(19) United States
(12) Patent Application Publication
(10) Pub. No.: US 2017/0371035 A1
(43) Pub. Date: Dec. 28, 2017

(54) PROTECTION AND GUIDANCE GEAR OR EQUIPMENT WITH IDENTITY CODE AND IP ADDRESS

(71) Applicant: Kiomars Anvari, Walnut Creek, CA (US)

(72) Inventor: Kiomars Anvari, Walnut Creek, CA (US)

(21) Appl. No.: 15/193,373

(22) Filed: Jun. 27, 2016

(51) Int. Cl. G01S 13/86; G01S 13/62; G01S 7/41

(52) U.S. Cl. CPC G01S 13/867; G01S 7/417; G01S 13/62

(57) ABSTRACT

A protection and guidance gear or equipment for monitoring and detection of impacts from surrounding objects. The protection and guidance gear or equipment comprises of a number of image sensors to record images, use images to estimate and calculate environment parameters, a number of wireless sensors to measure environment parameters, and a controller with artificial intelligence to process the information data from image processor and wireless sensor. The controller utilizes the received information data from image processors and wireless sensor to evaluate various environmental parameters which can be used to activate certain functions and devices.

This application is a continuation of application Ser. Nos. 62/157,936, 15/071,910, 14/161,949, and U.S. Pat. Nos. 9,262,910, 8,706,067, 8,891,696, 9,076,325 the entirety of which is expressly incorporated by reference herein

### BACKGROUND

Smart environments represent the next evolutionary development step in building, utilities, industrial, home, shipboard, and transportation systems automation. Like any sentient organism, the smart environment relies first and foremost on sensory data from the real world. Sensory data comes from multiple sensors of different modalities in distributed locations. The smart environment needs information about its surroundings as well as about its internal workings.

During most of the 20th century photography depended mainly upon the photochemical technology of silver halide emulsions on glass plates or roll film. Early in the 21st century this technology was displaced by the electronic technology of digital cameras. The development of digital image sensors, microprocessors, memory cards, miniaturized devices and image editing software enabled these cameras to offer their users a much wider range of operating options than was possible with the older silver halide technology.

One of the important sensors which can be used for smart environment is image sensor. Image sensors are used primarily in digital cameras and in a large number of imaging devices used in industrial, media, medical, and consumer applications. Image sensors are standard measurement tools to convert light to digital signal to be processed by a control processor.

There are two image sensors that dominate digital photography today: CCD (charge-coupled device) and CMOS (complementary metal-oxide semiconductor). Each image sensor has its place in the world but comes with very distinct advantages and disadvantages.

Both CCD and CMOS image sensors start at the same point—they have to convert light into electrons. It is somehow similar to how solar cells work. One simplified way to think about the image sensor is to think of it as having a 2-D array of thousands or millions of tiny solar cells, each of which transforms the light from one small portion of the image into electrons

Image sensors by definition convert electrons into voltage. However, there are different ways to get from point A to point B. A CMOS sensor has circuitry at every photo sensor. So each pixel is read simultaneously and then transmitted as digital information at once. This set up leaves the chip relatively crowded with circuitry but is extremely efficient and fast. In a CCD imager, the pixels are recorded on the chip and then one by one sent through the analog to digital converter to build the data. This takes more power than the CMOS process, but delivers much cleaner images.

CMOS sensors generally record less resolution than CCD sensors because they cannot physically sustain as many pixels on the plane of the chip. Each CMOS pixel is packaged with the circuitry to convert it to a digital signal, thus each sensor takes up more space.

CCD sensors tend to respond better to low light conditions than CMOS sensors. The clutter on CMOS sensors reduces the light sensitivity of the chip. It takes more lights to penetrate the thick layers, so dim light will not make it through. However, the advantage is that CMOS sensors facilitate adding gain to an image. Because circuitry is so close to each pixel, the camera can boost the exposure as it is recorded.

Wireless sensors are also used in smart environment. They are equipped with transmitters to convert signals from a control processor into a radio transmission. Then the reflected radio signal is interpreted by a receiver which then detects the received signal and sends it to a processor to be analyzed.

This patent application discloses use of image sensors for protection and guidance gear or equipment. The image sensor is applied to estimate and calculate the distance and approaching speed of an object in surrounding environment, and use this information data to activate functions or devices that provide protection, control and guidance. This application also discloses use of both wireless sensor that provides an identity in form of an IP address or identity code for the protection and guidance gear or equipment and image sensor for protection, control and guidance. The protection and guidance gear or equipment can be worn by human and robots.

### BRIEF DESCRIPTION OF THE DRAWINGS

FIG. 1 shows the parameters of a lens

FIG. 2 shows an embodiment of an image sensor

FIG. 3 illustrates an embodiment of a wireless sensing system.

FIG. 4 illustrates embodiment s of transmitter signal for wireless sensor.

FIG. 5 shows an embodiment of image sensor interaction with an object in its surrounding environment.

FIG. 6 illustrate an embodiment of an image/wireless sensor interaction with an object in its surrounding environment.

FIG. 7 illustrate embodiments of a flow chart of protection and guidance gear or equipment functions.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Range imaging is the name for a collection of techniques that are used to produce a 2D image showing the distance to points in a scene from a specific point, normally associated with some type of sensor device. The resulting image, the range image, has pixel values that correspond to the distance. If the sensor that is used to produce the range image is properly calibrated the pixel values can be given directly in physical units, such as meters.

Visual images are formed via the projection of light from the three-dimensional world onto a two dimensional sensor. In an idealized pinhole camera, all points lying on a ray passing through the pin-hole will be projected onto the same image position. Thus, information about the distance to objects in the scene (i.e., range) is lost. Distance information can be recovered by measuring the changes in the appearance of the world resulting from change in viewing position. Traditionally, this is accomplished via simultaneous measurements with two cameras at different positions, or via sequential measurements collected from a moving camera or object.

Three pillars of photography are Aperture, Shutter Speed and ISO. The camera's shutter speed, the lens's brightness (f-number), and the scene's luminance together determine the amount of light that reaches the sensor (the exposure). Exposure value (EV) is a quantity that accounts for the shutter speed and the f-number. Adjustment to the aperture controls the depth of field, the distance range over which objects are acceptably sharp; such adjustments need to be compensated by changes in the shutter speed.

In optics, the f-number (sometimes called focal ratio, or relative aperture) of an optical system is the ratio of the lens's focal length to the diameter of the entrance pupil.

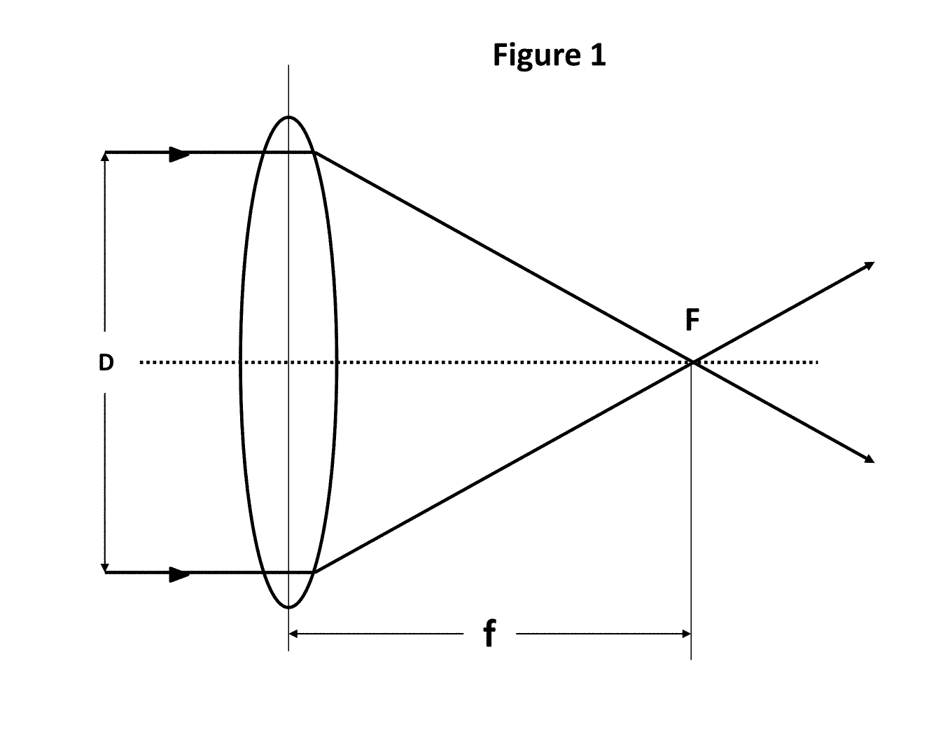

As shown in FIG. 1 the f-number N is given by:

$$N = \frac{f}{D}$$

where f is the focal length, and D is the diameter of the entrance pupil (effective aperture). It is customary to write f-numbers preceded by f/N, which forms a mathematical expression of the entrance pupil diameter in terms of f and N. For example, if a lens's focal length is 10 mm and its entrance pupil diameter is 5 mm, the f-number is 2 and the aperture diameter is f/2.

To maintain a consistent level of exposure, the shutter speed needs to be balanced with the aperture, and as one is increased, the other needs to decrease. For instance, smaller apertures (which let less light into the camera) require slower shutter speeds (to expose the sensor for longer). Wide apertures (more light) needs faster shutter speeds (less time) to produce the same exposure.

ISO stands for International Standards Organization, and it is a standardized industry scale for measuring sensitivity to light. This can be used in relation to how sensitive a sensor is to light, but more commonly today, it pertains to the sensitivity of a digital image sensor. ISO is measured in numbers, with the lowest number being the least sensitive to light, (e.g. ISO 50 or 100), and the highest number being the most sensitive to light, (e.g. ISO 6400). The higher the ISO the lower the amount of time a shutter needs to be open. Almost all digital cameras today allow you some control over your ISO settings, so it is important to know what it is, and what effect it has on your images.

The simplest formula to estimate distance to the object is pinhole projection formula:

$$\frac{x}{f} = \frac{X}{d}$$

Where x is the size of the object on the sensor, f is focal length of the lens, X is the size of the object, and d is distance from nodal point to the object. x and f, and X and d are measured in the same units, e.g. mm and m respectively. To calculate x one will need to estimate pixel size for the sensor; for example, for Pentax K20D it is 23.4 mm/4672 pixels≈5.008e-3 mm/pixel, i.e. a 100 pixels long image corresponds to x=500.08e-3 mm.

In the following, it is assumed that the size of the object (X) is unknown, and the only known parameters are x (image size) and f (focal length). The problem is that one cannot tell from one photo if a small object is very close to the camera or a big object far away, because the depth of field in landscape shots is usually very big (and that's why pinhole formula is applicable).

To solve this problem one may use two or more images to measure the distance. Provided one can measure all angles and distance between two camera positions, then it is possible to calculate distance to the remote object. But measuring all angles is not an easy task.

An easier approach is to take two photos which stay on the same line with the object, and the object in the center of the image. Let's assume the distance to the object on the first photo at time t₀ is d₁, and image size is X₁:

x₁/f=X/d₁ (1)

Then if the image sensor moves towards the object with speed of “v”, on the second photo after t₁ time passed, the image size is x₂ slightly bigger than x₁:

x₂/f=X/d₂ (2)

From equations (1), and (2) one has;

x₁*d₁=x₂*d₂ (3)

In the case of stationary object, considering the speed that the sensor approaches the object one has;

d₁−d₂=v*t₁ (4) therefore,

x₁*d₁−x₂*d₁=−x₂*v*t₁ (5) or

d₁=x₂*v*t₁/(x₂−x₁) (6) and

d2 can be obtain from equation (3).

If either the sensor or object or both are moving and we do not know the speed of neither of them, then we have two options;
1. use other means like GPS, speedometer (when mounted on automobiles, bicycles, motorbikes, etc.), wireless radio sensor, or other techniques (similar to what is used in helicopters, drone, airplane or etc.) to obtain the approaching speed of the object or
2. calibrate the image sensor for distance using a number of measurements and create a calibration matrix that relates the image size to distance of the object from the image sensor.
In the second approach, once Δd is estimated at two different times spaced by Δt, then Δd and Δt are used to calculate the speed. This speed can be used in equation 6 to recalculate distance.

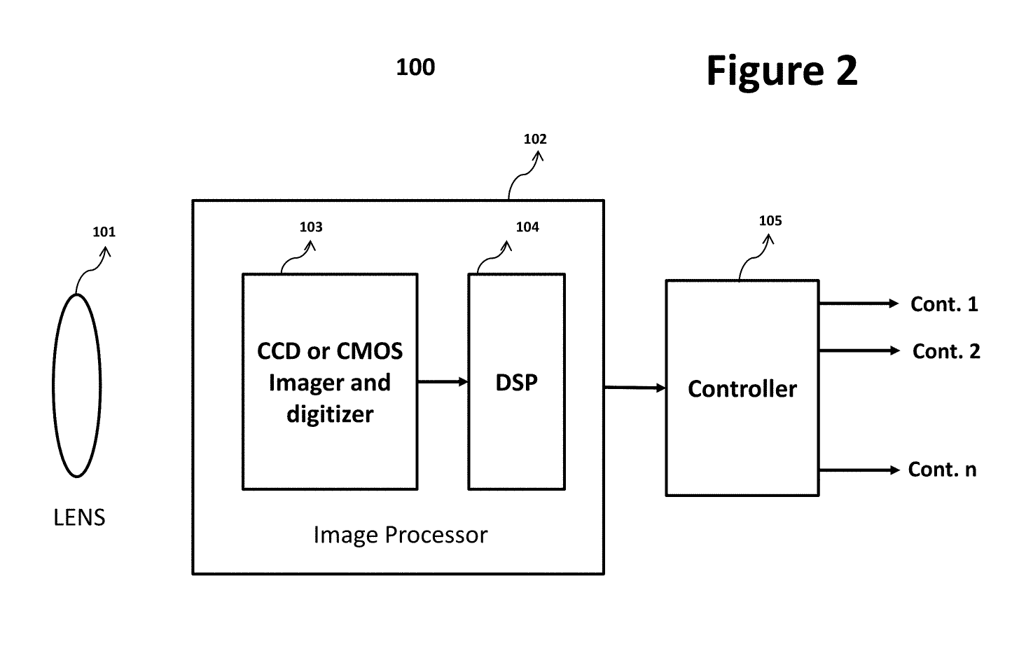

FIG. 2 depicts an embodiment of image sensor 100. In general, image sensor 100 facilitates estimation and calculation of certain parameters of environment by using the images from the environment. The images are produced through a lens 101 and an image processor 102 which comprises of an imager/digitizer 103 and a DSP (digital signal processor) 104. The image is processed in DSP 104 to identify an external object. Then through use of the pixels from multiple images and multiple lenses the approaching speed and distance of the object from image sensor are estimated. The speed and distance information is passed to a controller 105 to decide what function or device has to be activated.

Image sensor system 100 includes, among other things, control processor 105, image processor 102 and lens 101.

In one embodiment, control processor 105, image processor 102 and lens 101 are components of image sensor 100 that could be used for various applications. For example, it can be used in robotics, guided systems, automated automobiles, helmets, body armor worn by human or robot, traffic monitoring, flying car, any equipment or device that allows a human or robot to fly from point “A” to point “B”, and etc.

Control processor 105 is for processing information data received from image processor 102. Control processor 105 typically utilizes appropriate hardware and software algorithm to properly process the information data.

In one embodiment, the timing of collecting image data in image sensor 100 is defined by control processor 105.

In one embodiment, the imager/digitizer of image sensor 100 is of CCD type.

In one embodiment, the imager/digitizer of image sensor 100 is of CMOS type.

In one embodiment, the image sensor uses the information from pixels that belong to an identified object produced from multiple imagers and lenses to estimate some parameters of the environment.

In one embodiment, the DSP 104 has a variety of functions. In general, DSP 104 is utilized for signal processing, calculation, estimation of environmental parameters.

Control Processor 105 has a variety of functions. In general, control processor 105 is utilized for activities, methods, procedures, and tools that pertain to the operation, administration, maintenance, and provisioning of image sensor. In one embodiment, control processor 105 includes a database that is used for various applications. The database can be utilized for analyzing statistics in real-time.

Control processor 105 also has a variety of thresholds and tables (measurement information, etc) stored in the control processor memory or a removable memory card which can be similar to a subscriber identity module (SIM) card. In general, control processor 105 provides controls to various functions and devices. Moreover, control processor 105 is a high capacity communication facility that connects primary nodes.

In one embodiment image sensor 100 can be worn by human and robots.

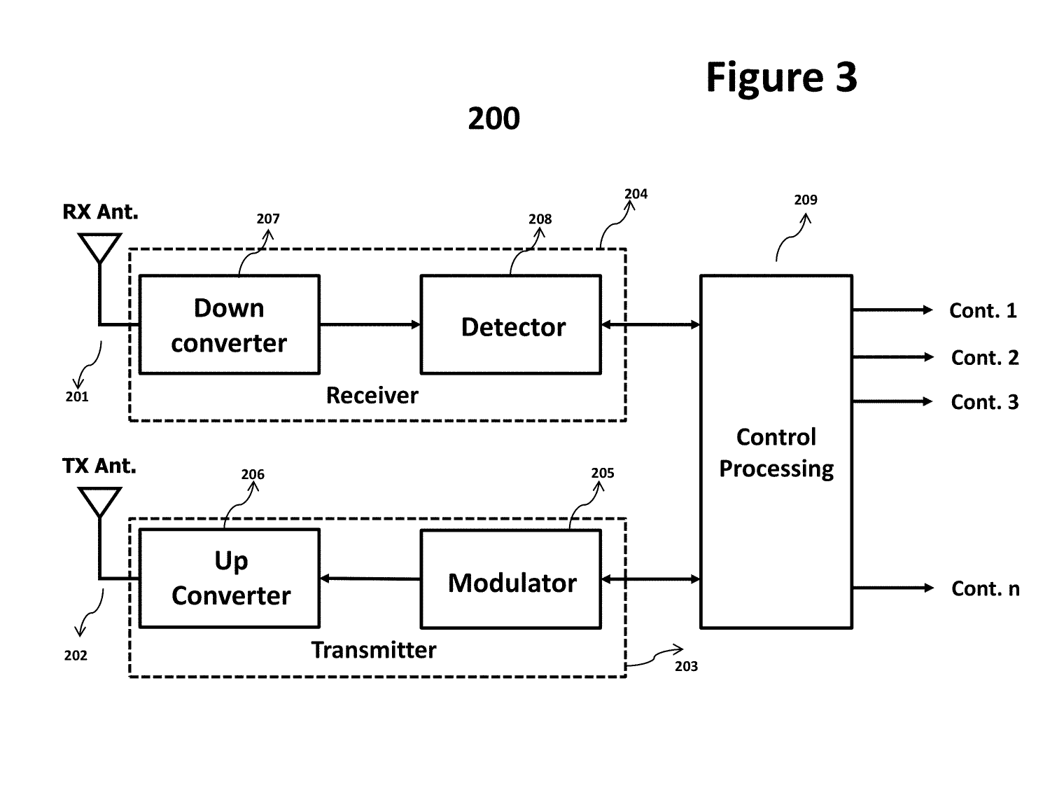

FIG. 3 depicts an embodiment of wireless sensor 200 used in a protection and guidance gear or equipment. In general, wireless sensor 200 facilitates estimation and calculation of certain parameters by transmitting a signal generated by a control processor 209 through a transmitter 203 and antenna 202 during a transmit period and after completion of transmission of the signal receiving the attenuated version of the reflected signal by an antenna 201 and receiver 204 during a period of time decided by the artificial intelligence in the control processor. For example, control processor 209 creates the transmit signal, send it to transmitter 203 for modulation by modulator 205 and up conversion to radio frequency by up convertor 206 and transmission through antenna 202. Then the signal from an object in the wireless sensor surrounding environment is received by antenna 201, down converted by down convertor 207, detected by detector 208 and send an indication to control processor 209. The down converter 207 also facilitates measurement of received signal strength (to decide if receive signal is valid) to provide to control processor 209.

Wireless sensor system 200 includes, among other things, control processor 209, transmitter 203, transmit antenna 202, receive antenna 201, receiver 204 and control processor 209.

In one embodiment, control processor 209, transmit antenna 202, transmitter 203, receive antenna 201, and receiver 204 are components of wireless sensor 200 that could be used for various applications. For example, it can be used in robotics, drone, automated automobile, bicycles, motorbikes, traffic monitoring, guided systems, flying car, any equipment or device that allows a human or robot fly from point “A” to point “B”, and etc.

In one embodiment, communications through wireless network 200 are by a transmit antenna 202 and a received antenna 201. Transmit and receive antennas are physically separated to provide sufficient isolation between transmit and receive antennas.

In one embodiment of wireless sensor, during the transmission of the signal receiver is not active. The transmission time is confined to duration of the transmit signal.

In one embodiment of wireless sensor 200, the receiver is active only when transmission is completed. Start and end of reception after completion of transmission is defined by control processor.

Control Processor 209 has a variety of functions including artificial intelligence since wireless sensor acts as a smart electronic eye for the protection and guidance gear or equipment and detects objects in the surrounding environment and identifies if any of the objects are approaching the wireless sensor. In addition to artificial intelligence control processor 209 is utilized for signal processing, calculation, estimation, activities, methods, procedures, and tools that pertain to the operation, administration, maintenance, and provisioning of wireless sensor.

In one embodiment, control processor 209 includes a database that is used for various applications. The database can be utilized for analyzing statistics in real-time.

Control processor 209 also has a variety of thresholds. In general, control processor 209 provides controls to various components that are connected to it. Moreover, control processor 209 is a high capacity communication facility that connects primary nodes.

In one embodiment of wireless sensor 200 used in a protection and guidance gear or equipment, the artificial intelligence within the control processor performs evaluation of the information data obtained from wireless sensor receiver, calculation and estimation, and defines various operation parameters like start and end of reception, the type of transmit signal, changes in transmit signal when needed, the length of transmit signal, the number of bits in the transmit signal pattern, carrier frequency of wireless sensor, bandwidth of wireless sensor, simplicity of implementation; the idle time between transmit and receive, the random or fix idle time between two transmission, the duration of measurement, the number of times to transmit and receive in the measurement time, how many measurement to perform, Idle/inactive time between two complete transmission and reception (the time between the end of reception and the start of transmission), the idle/inactive time between two complete measurement time, and to decide which function or device to activate and any other task that is required to make the wireless sensor to operate like a smart electronic eye.

In one embodiment of wireless sensor 200, the artificial intelligence within the wireless sensor allows the wireless sensor to act as a smart electronic eye for the protection and guidance gear or equipment and detect objects in the surrounding environment and identify if any of the objects are approaching the wireless sensor.

In one embodiment wireless sensor 200 can be worn by human and robot.

In one embodiment of wireless sensor 200, the devices that are activated by protection and guidance gear or equipment is inflatable airbags.

In one embodiment of wireless sensor 200, the devices that are activated by protection and guidance gear or equipment is expandable pads.

In one embodiment of wireless sensor 200, the pad that is activated by protection and guidance gear or equipment is polymer that expands by applying electrical voltage to it.

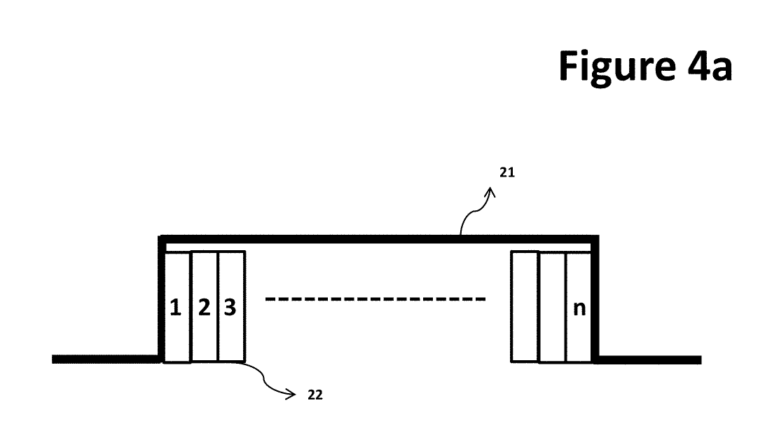

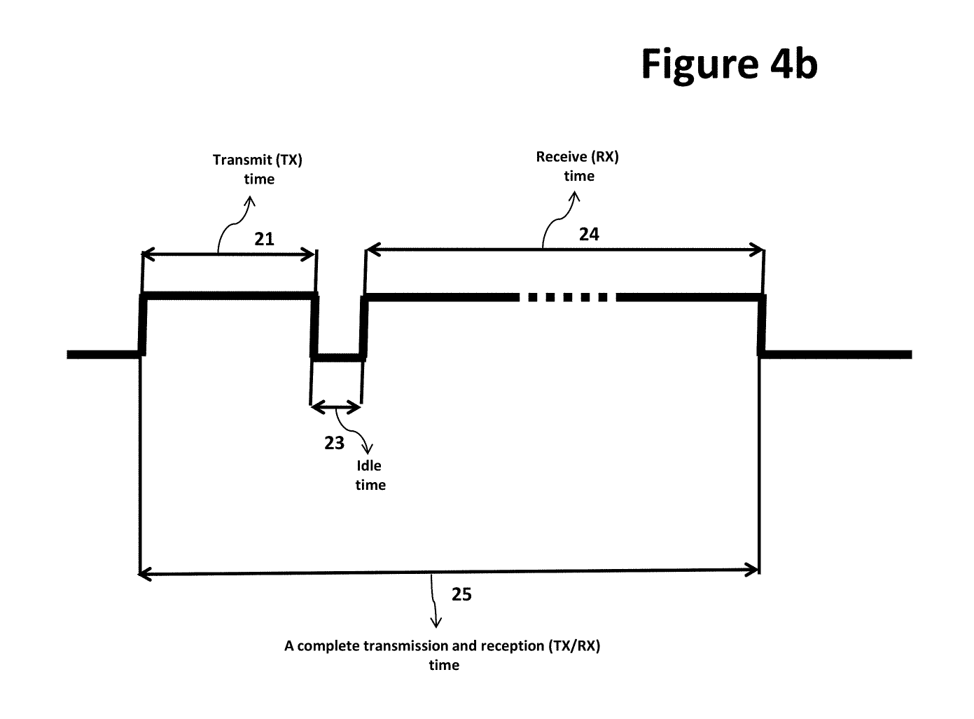

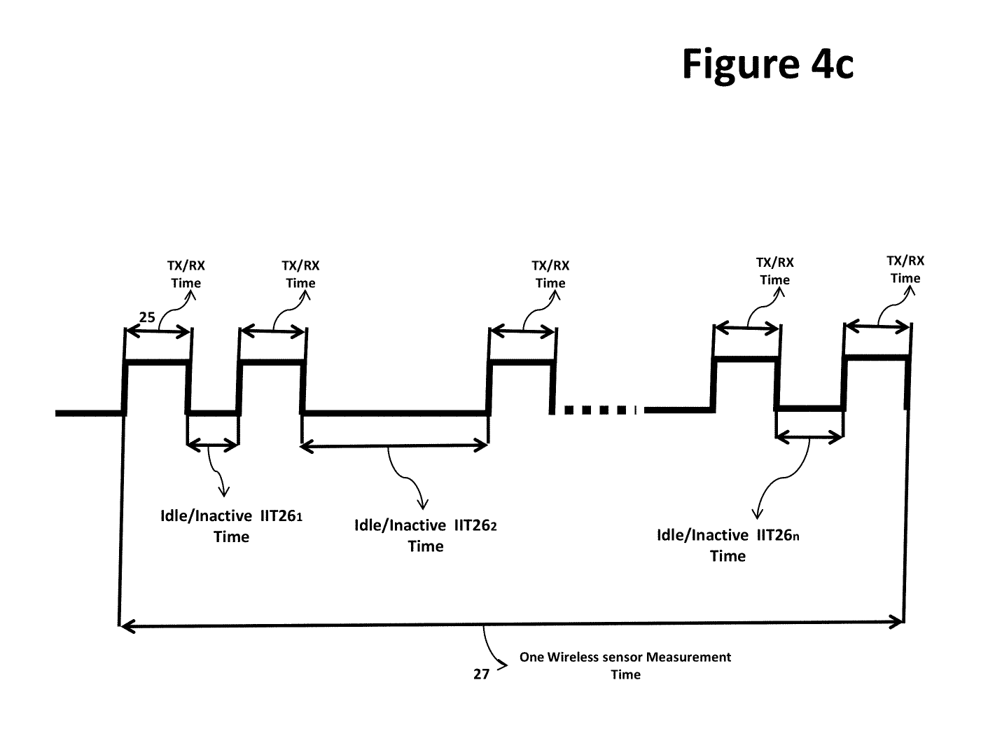

FIG. 4a depicts an embodiment of wireless sensor 200 transmit signal. The transmit signal has a durations 21 and a bit pattern 22. Pattern 22 can be a unique identity code, an IP address, or a random pattern which is generated by a control processor.

In one embodiment of wireless sensor 200 used in a protection and guidance gear or equipment, the random pattern can change each time the wireless sensor transmits.

In one embodiment of wireless sensor 200, the unique identity code can be assigned to protection and guidance gear or equipment at manufacturing.

In one embodiment of wireless sensor 200, the random pattern 22 can be different each time wireless sensor transmits. The wireless sensor can also transmit the random pattern a few times before changing it based on the artificial intelligence in the controller which evaluate the receive signal information data from wireless sensor. The change of transmit signal is for avoiding any collision or false detection from other signals in the surrounding environment.

In one embodiment of wireless sensor 200 the transmit signal 22 is an IP address (or identity code) unique to the protection and guidance gear or equipment. The IP address (or identity code) can be assign to the protection and guidance gear or equipment at manufacturing. The IP address (or identity code) can also be assign to the protection and guidance gear or equipment on the field by user. The IP address can be assigned each time the protection and guidance gear or equipment is turned on the same way that an Internet of things (IoT) device receives its IP address. The wireless sensor can change the IP address (or identity code) based on the artificial intelligence in the controller which evaluate the receive signal information data from wireless sensor. The IP address (or identity code) can also be taken from a pool of IP addresses (or identity codes) stored in the control processor memory or a removable memory card which can be similar to a subscriber identity module (SIM) card.

In one embodiment of wireless sensor 200, the transmit duration 21 based on simplicity of implementation depends on the number of bit pulses in the transmit signal pattern which is defined by wireless sensor carrier frequency and bandwidth based on simplicity of implementation. The higher the number of bits in transmits identity code, IP address, or random pattern the higher the carrier frequency and bandwidth.

In one embodiment of wireless sensor 200, the duration 21 defines the accuracy of measurement of surrounding environment parameters.

In one embodiment of wireless sensor 200, the number of bits in the pattern 22 defines the accuracy of the receiver detection.

FIG. 4b shows the duration of a complete transmission and reception 25 for wireless sensor 200. The complete transmission and reception duration comprises of the transmit duration 21, idle time 23 and receive duration 24.

In one embodiment of wireless sensor 200, the idle time 23 can be zero. The idle time can vary based on proximity of an object to protection and guidance gear or equipment in its surrounding environment. The closer the object the smaller the idle time 23.

In one embodiment of wireless sensor 200, the reception time 24 depends on the monitoring radius of surrounding environment by the protection and guidance gear or equipment. The bigger the radius of monitoring the longer the reception time of wireless sensor.

FIG. 4c shows the duration of one complete measurement time 27 of wireless sensor 200. It comprises of “n+1” complete transmission and reception (TX/RX) times 25 and the idle/inactive times IIT26₁ to IIT26ₙ between TX/RX times.

In one embodiment of wireless sensor 200, idle/inactive times IIT26₁ to IIT26ₙ can have the same duration or randomly different duration based on artificial intelligence assessments. Artificial intelligence within wireless sensor control processor defines the idle/inactive time duration to avoid any reception collision from transmit signals from other devices or other protection and guidance gears or equipment in the surrounding environment of the protection and guidance gear or equipment.

In one embodiment of wireless sensor 200, the artificial intelligence within the control processor of protection and guidance gear or equipment can use a number of measurement times 27 for assessment of the surrounding environment before reaching a point to activate any function or devices.

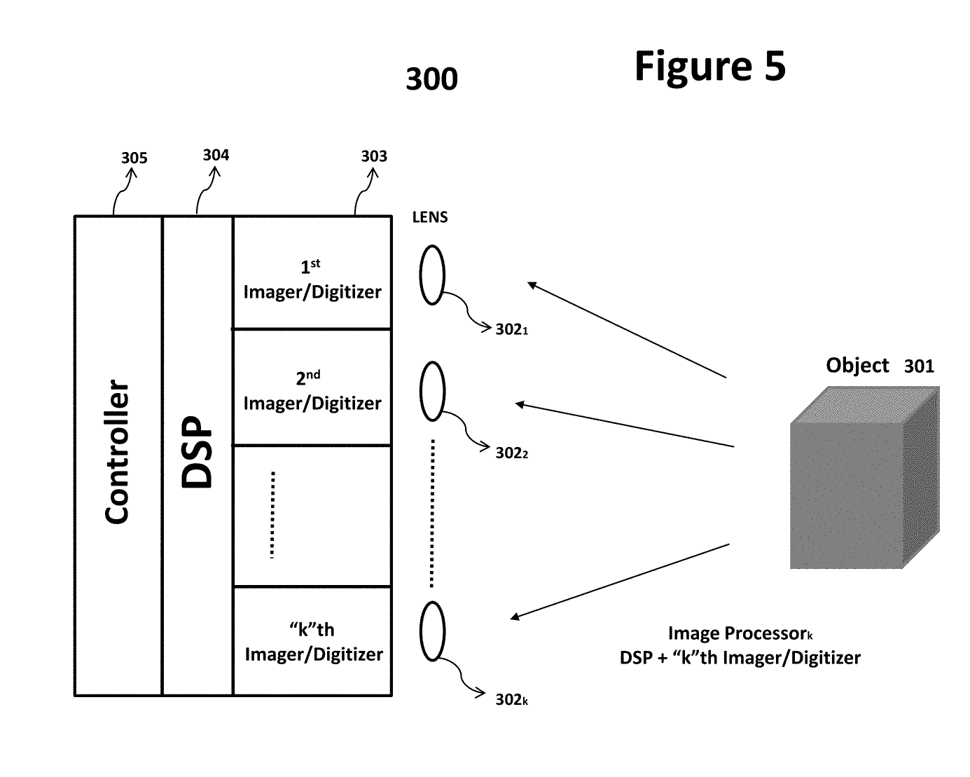

FIG. 5 depicts an embodiment of image sensor 300 interactions with one object in its surrounding environment. In general, image sensor system includes controller 305, DSP 304, “k” Imager/digitizer 303, and lenses 302₁ to 302ₖ.

Controller 305 request information from one of imager/digitizers 303 by sending an activation signal. The imager/digitizer receives the activation signal and record an image from external object 301 in its surrounding environment.

In one embodiment of image sensor 300 used in a protection and guidance gear or equipment, DSP 304 processes the recorded images from a number of lenses and extracts the needed information data to estimate the required parameters from object 301 to send to controller 305. The controller 305 uses the information data received from DSP 304 to decide which function or device needs to be activated.

In one embodiment of image sensor 300 used in a protection and guidance gear or equipment, the image sensor's parameters (f-number, focal length, effective aperture), and pixels in the object's image are used to estimate and calculate distance of the object in surrounding environment from image sensor and the approaching speed of the object towards image sensor.

In one embodiment of image sensor 300 used in a protection and guidance gear or equipment, when both the object and image sensor are moving the image sensor uses other means like GPS, speedometer (when mounted on automobiles, bicycles, motorbikes, etc.), wireless radio sensor, or other techniques (similar to what is used in helicopters, drone, airplane or etc.) to obtain the approaching speed of the object in order to estimate and calculate the distance of the object from image sensor.

In another embodiment of image sensor 300 used in a protection and guidance gear or equipment, when both the object and image sensor are moving the image sensor is calibrated for distance using a number of measurements to create a calibration matrix that relates the image size to distance of the object from the image sensor. Once the distance is calculated using the pixels from the images of an object then the speed of approaching object in surrounding environment is calculated and estimated.

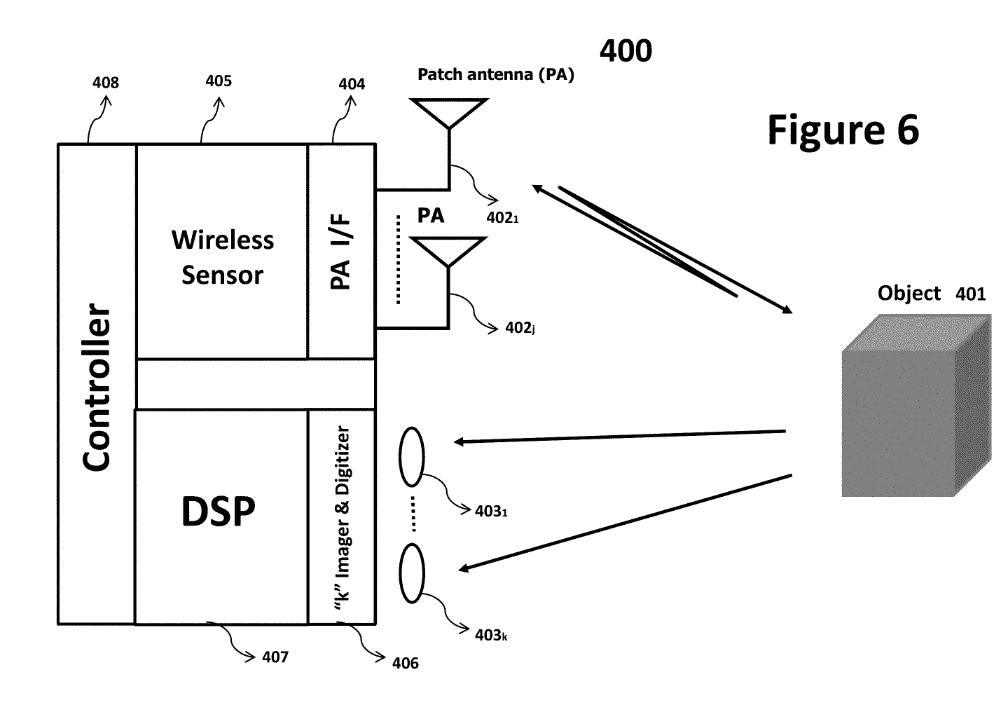

FIG. 6 depicts an embodiment of image/wireless sensor 400 (used in a protection and guidance gear or equipment) interactions with an object in the surrounding environment. In general image/wireless sensor 400 includes controller 408, DSP 407, “k” Imager/digitizer 406, lenses 403₁ to 403k, wireless sensor 405, antenna interface 404, and antennas 402₁-402ⱼ which can be patch antenna (PA).

Controller 408 requests information from one of imager/digitizers 406 and wireless sensor 405 by sending an activation signal. The imager/digitizer receives the activation signal then record an image from external object 401 and wireless sensor receives the activation signal then configures antennal interface 404 for transmission and reception from one of the antennas 402₁-402ⱼ.

In one embodiment of image/wireless sensor 400 used in a protection and guidance gear or equipment, DSP 407 processes the recorded images from a number of lenses and extracts the needed information data to estimate the required parameters for object 401 in the surrounding environment and sends them to controller 408. Wireless sensor also configures antennal interface 404 for transmission and reception from one of the antennas 402₁-402ⱼ and collect the appropriate information data for object 401 to send to controller 408. The controller 408 uses the information data received from DSP 407 and wireless sensor 405 to decide which function or device needs to be activated.

In one embodiment image/wireless sensor 400 can be worn by human and robots.

In one embodiment image/wireless sensor 400, the devices that are activated by protection and guidance gear or equipment is inflatable airbags.

In one embodiment image/wireless sensor 400, the devices that are activated by protection and guidance gear or equipment is expandable pads.

In one embodiment image/wireless sensor 400, the pad that is activated by protection and guidance gear or equipment is polymer that expands by applying electrical voltage to it.

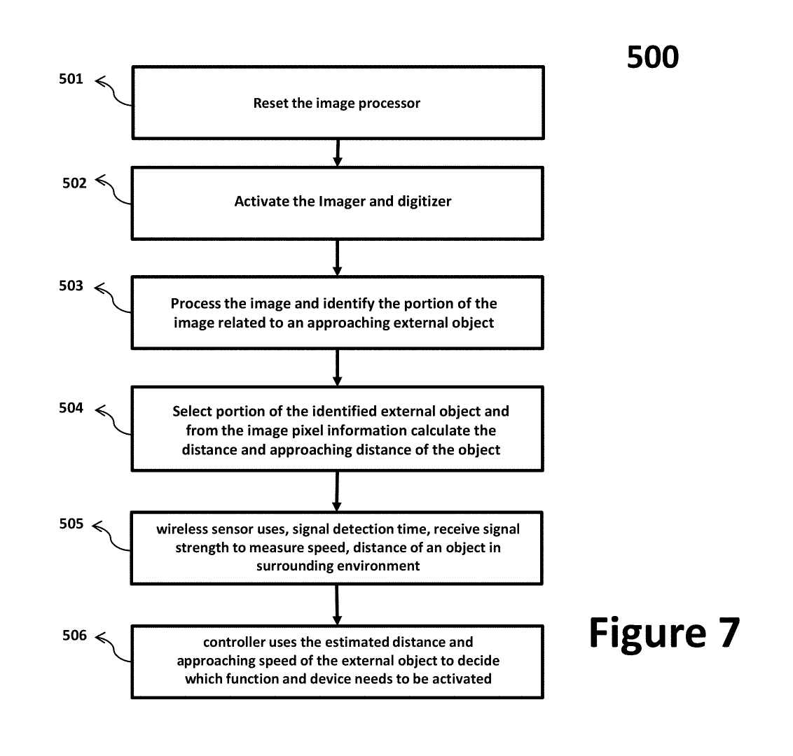

FIG. 7 depicts an embodiment of method 500 for using an image/wireless sensor to estimate and calculate environmental parameters. In various embodiments, method 500 is carried out by processor, imager/digitizers and lenses under the control of processes or executable instructions. The readable and executable instructions reside, for example, in a data storage medium such as processor usable volatile and non-volatile memory. However, the readable and executable instructions may reside in any type of processor readable storage medium. In some embodiments, method 500 is performed at least by one of the circuits described herein.

At 501 of method 500, the image processor is reset.

At 502 of method 500, the imager/digitizer is activated.

At 503 of method 500, the recorded image from imager/digitizer is processed to identify the portion of the image related to an approaching external object.

At 504 of method 500, a portion of the identified external object is selected and from the image pixels information the distance and approaching speed of the object is estimated.

At 505 of method 500, wireless sensor uses, signal detection time, receive signal strength to measure speed, distance of an object in surrounding environment.

At 506 of method 500, the controller uses the estimated distance and approaching speed of the external object to decide which function and device needs to be activated.

Various embodiments are thus described. While particular embodiments have been described, it should be appreciated that the embodiments should not be construed as limited by such description, but rather construed according to the following claims.

1. A protection and guidance gear or equipment for monitoring an object in its surrounding environment comprising:
a plurality of image sensors to provide a plurality of images of surrounding environment comprising:
a plurality of lenses;
a plurality of imagers;
a digital signal processing (DSP) to use a plurality of pixels from the plurality of images to calculate a distance and an approaching speed of an object in surrounding environment;
a wireless sensor to transmit a signal and detect the signal from surrounding environment comprising:
a plurality of transmit and receive antennas;
a transmitter using a transmit antenna to transmit the signal, which is a unique signal, like at least one of an IP address, identity code, or a random pattern generated in a control processor where the transmission information is recorded;
a receiver using a receive antenna to receive the signal from surrounding environment, to detect the signal from the object in surrounding environment and send the signal to a control processor;
a control processor to use the signal to estimate a distance and an approaching speed of the object in surrounding environment, to receive the estimated distance and approaching speed of the same object from the DSP and to evaluate all the information data using an artificial intelligence within the control processor to activate certain functions and devices based on the estimated distances and speeds of the object from the wireless sensor and the plurality of image sensors.

2. The protection and guidance gear or equipment described in claim 1, wherein the image sensor's parameters (f-number, focal length, effective aperture), and pixels in the object's image are used to estimate and calculate the distance of the object in surrounding environment from image sensor and the approaching speed of the object towards image sensor.

3. The protection and guidance gear or equipment described in claim 1, wherein the plurality of image sensors can use charge-coupled device (CCD) or complementary metal-oxide semiconductor (CMOS) technologies.

4. The protection and guidance gear or equipment described in claim 1, wherein the image sensor is calibrated for distance using a number of measurements to create a calibration matrix that relates the image size to distance of the object from the image sensor and stored in the control processor memory or a removable memory card which is similar to a subscriber identity module (SIM) card.

5. The protection and guidance gear or equipment described in claim 1, wherein the image sensor first calculates the distance using the pixels from the images of the object using the calibration matrix and then the speed of approaching object in surrounding environment is calculated and estimated.

6. The protection and guidance gear or equipment described in claim 1, wherein GPS, speedometer, or wireless sensor is used to obtain the approaching speed of the object in the surrounding environment for image processor to calculate and estimate the distance of the object from image sensor.

7. The protection and guidance gear or equipment described in claim 1, wherein the device activated by the protection and guidance gear or equipment is at least one of the inflatable airbag, or expandable pads made of polymer that expands when electric voltage applied to it.

8. The protection and guidance gear or equipment described in claim 1, wherein the protection and guidance gear or equipment using the image sensor, the wireless sensor or both is used for at least one of helmet, body armor worn by human or robot, robotics, drone, automated automobile, bicycle, motorbike, traffic monitoring, guided systems, flying car, and any equipment or device that allows a human or robot to fly.

9. The protection and guidance gear or equipment described in claim 1, wherein the wireless sensor transmit signal is changed each time wireless sensor transmits or is changed after a few transmission determined by the artificial intelligence in the controller which evaluates the receive signal information data from the wireless sensor.

10. A wireless sensor used in a protection and guidance gear or equipment comprising:
a transmitter using a transmit antenna to transmit a signal which is a unique pattern during a transmit time;
a transmit signal stored or generated in a control processor supporting at least one of IP address, identity code, or a random pattern;
a receiver using a receive antenna to receive the signal from surrounding environment during a receive time which follows an idle time after the transmission time, to detect the signal from an object in surrounding environment and send the signal to a control processor;
a control processor with artificial intelligence capability to determine the type of the signal, number of bits in the signal, idle time, receive time, measurement time, number of measurements, to evaluate and validate receive signal from the object in the surrounding environment, to calculate and estimate a distance and an approaching speed of the object in the surrounding environment from received information data, and to determine when and which function or device to activate.

11. The wireless sensor described in claim 10, wherein the idle or inactive time between end of transmission and beginning of reception is zero or higher based on the monitoring radius of the wireless sensor.

12. The wireless sensor described in claim 10, wherein a complete TX/RX time is the sum of the transmission time, idle time between end of transmission and beginning of reception, and reception time which is based on the radius of monitoring of the wireless sensor.

13. The wireless sensor described in claim 10, wherein the measurement time is the sum of a plurality of TX/RX times and the random idle or inactive time between two TX/RX times.

14. The wireless sensor described in claim 10, wherein the idle time between two TX/RX time is random and is defined by the artificial intelligence in the control processor to avoid any collision with other signals in the surrounding environment that are different from wireless sensor transmit signal.

15. The wireless sensor described in claim 10, wherein the artificial intelligence defines all random idle/inactive times and number of TX/RX times within the wireless sensor's measurement time which results to all measurement times has different duration.

16. The wireless sensor described in claim 10, wherein the artificial intelligence within the wireless sensor allows the wireless sensor to act as a smart electronic eye for the protection and guidance gear or equipment and detect objects in the surrounding environment and identify if any of the objects are approaching the wireless sensor.

17. The wireless sensor described in claim 10, wherein the transmit signal duration depends on the number of bit pulses in the transmit signal which is defined by wireless sensor carrier frequency and bandwidth based on simplicity of implementation of wireless sensor, and the higher the number of bits in the transmit identity code, IP address, or random pattern the higher the carrier frequency and bandwidth.

18. The wireless sensor described in claim 10, wherein the random transmit signal pattern can be changed each time the wireless sensor transmits or changed by artificial intelligence in the control processor after a few transmissions to avoid any false detection from signals transmitted by other sources or gears and equipments in the surrounding environment.

19. The wireless sensor described in claim 10, wherein the IP address or identity code is unique to the protection and guidance gear or equipment, can be assign to the protection and guidance gear or equipment at manufacturing, or can be assign to the protection and guidance gear or equipment in the field by user.

20. The wireless sensor described in claim 10, wherein the IP address can be assigned each time the protection and guidance gear or equipment is turned on the same way as an Internet of things (IoT) device, or the artificial intelligence in the controller of the wireless sensor that evaluates the receive signal information data changes the IP address by using an IP address from a pool of IP addresses stored in the control processor memory or a removable memory card which can be a subscriber identity module (SIM) card.
